(19) United States
(12) Patent Application Publication
(10) Pub. No.: US 2015/0149280 A1
(43) Pub. Date: May 28, 2015

(54) METHOD AND APPARATUS FOR TRANSMITTING AN OFFER FOR AN ITEM

(71) Applicant: AT&T Intellectual Property I, L.P., Atlanta, GA (US)

(72) Inventors: GREGORY NELSON PATTERSON, Atlanta, GA (US); Pradeep Khowash, Marlboro, NJ (US); Mark S. Wuthnow, Austin, TX (US)

(73) Assignee: AT&T Intellectual Property I, L.P., Atlanta, GA (US)

(21) Appl. No.: 14/092,830

(22) Filed: Nov. 27, 2013

(51) Int. Cl. G06Q 30/02; G06Q 50/00

(52) U.S. Cl. CPC G06Q 30/0261; G06Q 30/0255; G06Q 30/0267; G06Q 50/01
USPC 705/14.53

(57) ABSTRACT

A method, computer-readable storage device and apparatus for transmitting an offer for an item are disclosed. For example, a method receives from a social network an indication of a desire of a user for an item and receives from a device of a retailer an indication of an offer for the item. The method then determines a location of a device of the user, detects a proximity of the device of the user to a location of the retailer and transmits the offer for the item to the device of the user when the proximity of the device of the user to the location of the retailer is detected.

The present disclosure relates generally to communication networks and more particularly to methods, computer-readable storage devices and apparatuses for conveying offers for products and services from retailers to users based upon the users' social network activities and the users' locations in relation to such retailers.

### BACKGROUND

Many online social networks monetize advertisements that are displayed to users while browsing the online social network/website, with advertisements targeted to users based on profile data, the contacts of a user, user activity and so forth. Similarly, telecommunications network service providers may provide targeted advertisements based upon a user's internet usage, television watching history and so forth. In some cases, the targeted advertisements seek to generate online purchases through clicking on the advertisement. Other targeted advertisements provide coupons which may be printed or saved to a user device to later present in-person at a store. However, even with such targeted advertisements, the success rate is typically very low.

### SUMMARY

In one embodiment, the present disclosure discloses a method, computer-readable storage device and apparatus for transmitting an offer for an item. For example, a method receives from a social network an indication of a desire of a user for an item and receives from a device of a retailer an indication of an offer for the item. The method then determines a location of a device of the user, detects a proximity of the device of the user to a location of the retailer and transmits the offer for the item to the device of the user when the proximity of the device of the user to the location of the retailer is detected.

### BRIEF DESCRIPTION OF THE DRAWINGS

The teaching of the present disclosure can be readily understood by considering the following detailed description in conjunction with the accompanying drawings, in which:

FIG. 1 illustrates an exemplary network related to the present disclosure;

FIG. 2 illustrates a timing diagram of an exemplary communication system, in accordance with the present disclosure;

FIG. 3 illustrates a flowchart of a method for transmitting an offer for an item, in accordance with the present disclosure; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses methods, computer-readable storage devices and apparatuses for transmitting an offer for an item. Although the present disclosure is discussed below in the context of wireless access networks and an Internet Protocol (IP) network, the present disclosure is not so limited. Namely, the present disclosure can be applied to packet switched or circuit switched networks in general, e.g., Voice over Internet Protocol (VoIP) networks, Service over Internet Protocol (SoIP) networks, Asynchronous Transfer Mode (ATM) networks, Frame Relay networks, and the like.

In one embodiment, the present disclosure provides a system in which a telecommunication network service provider or other entity aggregates analytics data relating to a specific user, e.g., a subscriber from various sources for various services. For example, the telecommunication network service provider may integrate the analytics data collected from other sources, such as other service providers, social networks, retailers/vendors and the like with user profile information stored by the telecommunication network service provider. For example, analytics data, e.g., raw usage data and or pre-processed data, may be collected from social networking partners to determine what kinds of things the user likes, the user's hobbies and interests, and so forth. Additional analytics data related friends and family, e.g., friends' desires, purchases, recommendations and the like, can also be captured from one or more social networks. Similarly, analytics data may also be collected by the telecommunication network service provider from retailers, or vendors, such as department stores, home improvement stores, furniture stores, banks, insurance companies, and so forth, which reflects the user's buying habits and needs, the brands he or she may prefer and so forth. In another embodiment, analytics data may comprise ratings by a user provided to one or more websites, e.g., product ratings on amazon.com®, yellowpages.com®, yelp.com® and so forth. In one embodiment, all of these different sources of user data/analytics data are aggregated and analyzed by the telecommunications network service provider such that a set of targeted services (e.g., advertisements) with incentives can then be offered to the user.

In parallel, the telecommunications network service provider may also receive updates for offers relating to products and services from one or more retailers. For example, in one embodiment the telecommunications network service provider provides a matching service to retailers/vendors to match users with desired products and service and to enable retailers to reach users who are prospective customers. In particular, in one embodiment the telecommunications network service provider tracks the location of a particular user, e.g., based upon the location information of the user's mobile endpoint device, and then matches the user to an offer from a retailer for a product or service.

In one embodiment, the matching is based upon the user's desire for the particular product or service, the retailer's interest in selling the particular product or service and the detection of the user's proximity to a location of the retailer. For instance, in one embodiment a user may indicate, e.g., within an online social networking context, a desire for a particular product. This information may then be aggregated by the telecommunications network service provider when it periodically queries the social network for users' analytics data. In addition, a retailer may indicate to the telecommunications network service provider that the retailer has a specific offer of the product which the retailer desires to sell and which the retailer would like to have presented to relevant users. In one embodiment, the offer may include a price and a geographic zone in which the offer is applicable, e.g., users who are already at a shopping mall in which the retailer's store is located. At some later time, the telecommunications network service provider may then detect that the user has traveled into the geographic zone. In other words, the user may have traveled to the mall for some other purpose. In addition, the telecommunications network service provider may have noted that the user has expressed a desire for the same item that is the subject of the retailer's offer. Accordingly, the telecommunications network service provider may convey the offer from the retailer to the user at the time the user is detected to be present within the geographic zone, e.g., the user is now present at the mall. Advantageously, the telecommunications network service provider is able to present the offer to the user at a time and location that is more likely to generate a transaction between the user and the retailer. Further illustrative examples are described in greater detail below.

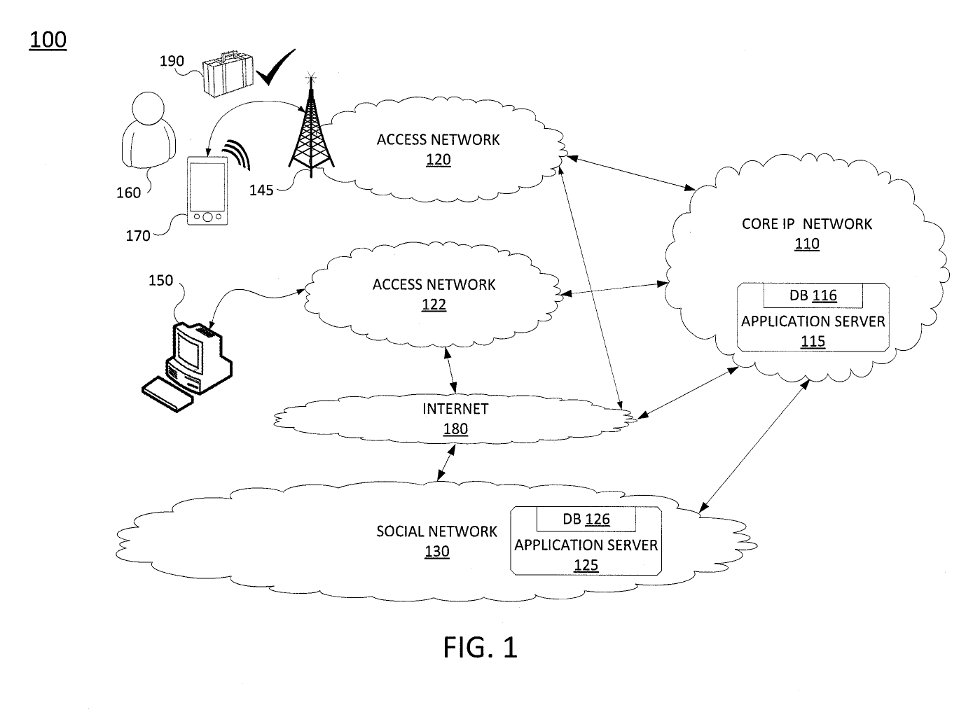

To aid in understanding the present disclosure, FIG. 1 illustrates a block diagram depicting one example of a communication network 100 suitable for performing or enabling the steps, functions, operations and/or features described herein. The overall communication network 100 may include any number of interconnected networks which may use the same or different communication technologies, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, and the like), a long term evolution (LTE) network, and so forth. It should be noted that an IP network is broadly defined as a network that uses Internet Protocol to exchange data packets.

As shown in FIG. 1, the system 100 connects endpoint device 170 with one or more application servers via a core network 110, access networks 120 and 122, social network 130 and/or Internet 180. In one embodiment, core network 110, e.g., an IP network, interfaces with one or more of the access networks 120 and 122, and may also include interfaces to the Internet 180 and/or social network 130. Access network 120 may comprise a wireless access network (e.g., an IEEE 802.11/Wi-Fi network and the like) or a cellular access network, and may include a cellular base station and/or wireless access point 145. In one embodiment, access network 122 may comprise a PSTN access network, a cable access network, a wired access network and the like. In one embodiment, the access networks 120 and 122 and the core network 110 may be operated by different service providers, the same service provider or a combination thereof. Various interconnections between access networks 120 and 122, core network 110, Internet 180 and social network 130 are shown. In accordance with the present disclosure, it is contemplated that devices may utilize any one or a combination of such networks and interfaces in order to communicate with one another.

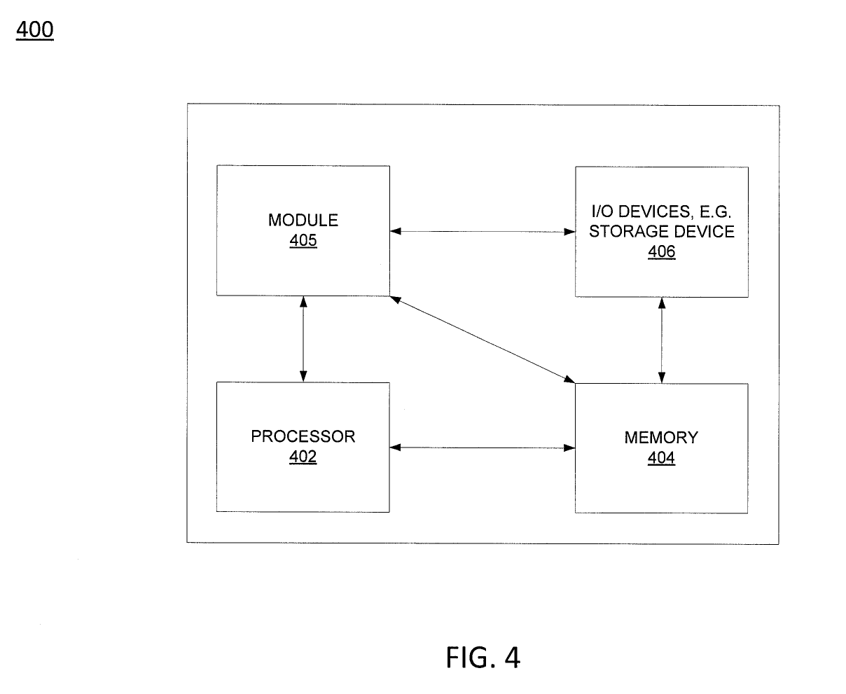

In one embodiment, the core network 110 may include an application server (AS) 115 and a database (DB) 116. Although only a single AS 115 and a single DB 116 are illustrated, it should be noted that any number of application servers 115 or databases 116 may be deployed. In one embodiment, the AS 115 may comprise a general purpose computer as illustrated in FIG. 4 and discussed below. In one embodiment, the AS 115 is configured to perform steps, functions and/or operations for transmitting an offer for an item, in accordance with the present disclosure. As such, DB 116 may store program code, data, files, and so forth to enable such functions. Thus, various embodiments are described herein as residing in or being performed in whole or in part by AS 115. However, it should be noted that, social network 130 may include an application server (AS) 125 and a database (DB) 126, which may be the same or similar to AS 115 and DB 116 in the core network 110 and which are also suitable to perform at least the same functions. Similarly, in another embodiment a stand-alone application server (not shown), e.g., connected to Internet 180, may perform the same or similar functions. For example, the steps, functions and/or operations of the present disclosure may be performed by an entity other than a telecommunications network service provider. In addition, although DB 116 and DB 126 are illustrated as components of AS 115 and AS 125 respectively, in another embodiment DB 116 and/or DB 126 may comprise separate devices. In other words, DB 116 and/or DB 126 may comprise a data store or a data repository residing on a storage device that is different from AS 115 or AS 125 respectively.

In one embodiment, endpoint device 170 comprises an endpoint device configured for wireless or wired communication such as a personal computer, a laptop computer, a Personal Digital Assistant (PDA), a mobile phone, a smart phone, an email device, a tablet, a messaging device, and the like. As illustrated in FIG. 1, endpoint device 170 may belong to a user 160. In one embodiment, the user 160 may be a subscriber of access network 120 and/or core network 110. Accordingly, in one embodiment DB 116 of AS 115 in core network 110 may store profile information of user 160 which may include a name, billing address, service address, telephone number, email address, contact list, address book, calendar information and so forth associated with user 160. The profile information may also include geographic location information regarding user 160. For example, location information may be determined from a source IP address associated with communications from endpoint device 170, global positioning system (GPS) information of endpoint device 170, serving base station information, and so forth. In one embodiment AS 115 automatically collects location information from one or more of such sources. However, in another embodiment endpoint device 170 may periodically report location information to AS 115.

In one embodiment, AS 115 stores in DB 116 stores additional information that is obtained from social network 130 in the profile of user 160. For example, in addition to being a subscriber of access network 120 and/or core network 110, user 160 may also participate in social networking via social network 130. In one embodiment, social network 130 may store analytics data and profile data regarding members of the social network in DB 126 of AS 125, broadly referred to herein as social network information. For example, each member of the social network 130 may have a social network profile that includes: posts and messages of the user, biographic information of the user, information on contacts of the user and/or other participants of the social network with whom the user has interacted, location/check-in information of the user, and so forth.

In one embodiment, each social network profile may also include products, services and other items that the user likes or desires, different restaurants, vendors/retailers, schools, locations, musicians and events that the user like, and so forth. For example, as illustrated in FIG. 1, the user 160 may see a new item 190 that the user desires, e.g., a suitcase. Thus, the user may provide an indication to the social network 130 that the user 160 likes, or desires the item 190. In one example, contacts of the user 160 may be presented with a social network posting or update from user 160 indicating that user 160 wants the item 190. At the same time, the user's desire for the item 190 may also be stored in analytics data relating to user 160 in DB 126. In addition, the analytics data relating to user 160 may further include the likes, interests and desires of one or more contacts of user 160. For example, user 160 may explicitly indicate a desire for item 190, while one or more contacts of user 160 may also indicate a desire for the same item 190, or may have actually completed a purchase of the item 190. Thus, by including additional analytics data derived from the social network activities of the user 160's contacts, a party utilizing the analytics data may determine that the user 160 is a stronger prospect to purchase item 190, bolstered by the related activity of the user 160's contacts. In addition, a measure of the user 160's influence over contacts of the user may also be derived from the social network activities of the user 160's contacts. For example, user 160 may first indicate that he or she likes an item, followed by one or more contacts indicating a desire for the same item. In this case, a party analyzing the social network information may determine that user 160 is a potential influencer of one or more of the contacts.

In any event, in one embodiment AS 115 may periodically query AS 125 of social network 130 to retrieve social network information regarding user 160 from DB 126 to be used as an alternative to or in conjunction with information previously available to AS 115. For example, the telecommunications network service provider may subscribe to analytics data updates from social network 130 with regard to users/subscribers of core network 110 and/or access network 120 who are also members of the social network 130. In addition, in one embodiment, AS 115 may obtain additional information regarding user 160 from one or more retailers. For example, retailer device 150 may comprise a server of a retailer such as a department store, a home improvement store, a tax preparation firm, an insurance company and so forth. Retailer device 150 may therefore store information regarding the purchasing history and habits of various users, including user 160. For example, the purchasing history may indicate that user 160 is a regular patron of a particular chain restaurant, regularly purchases clothes of a particular brand and so forth. Thus, in one embodiment AS 115 may periodically query retailer device 160 to obtain this additional user data. Notably, AS 115 may utilize information pertaining to user 150 derived from any one or more of the above described sources to determine a need or a desire of the user for one or more specific items, e.g., a product or a service. For illustrative purposes, the present example shows that user 160 has indicated to social network 130 a desire for item 190.

As mentioned above, in one embodiment a telecommunications network service provider may provide a service to retailers to present offers for products and services to users/subscribers. Thus, in the present example, a retailer associated with retailer device 150 may enroll in such a service that may be provided by core network 110 via AS 115. In one embodiment, AS 115 may gather offer information from retailer device 150, as well as from other retailers, pertaining to offers for products and services. Offers may comprise special sales for products and services and may have a limited duration, e.g., good for one day, one week and so forth. In one embodiment, offers may have an associated geographic range, a geographic zone or a geofence. For example, a retailer associated with retailer device 150 may have an offer for the sale of item 190, but only at a particular store located in city X. Thus, the retailer's offer may be specified to only be applicable to users who may be within city X, within the county in which city X resides, within a 5 mile radius of the store, and so forth. As still another example, the retailer may desire that the offer only be applicable to users who are within a short walking distance of the store. For example, the offer may only be applicable to users who are within the same shopping plaza or shopping mall where the store is located, within 500 meters of the store, within 200 meters of the store and so forth. Thus, AS 115 may also store in DB 116 current offers of this nature from one or more retailers.

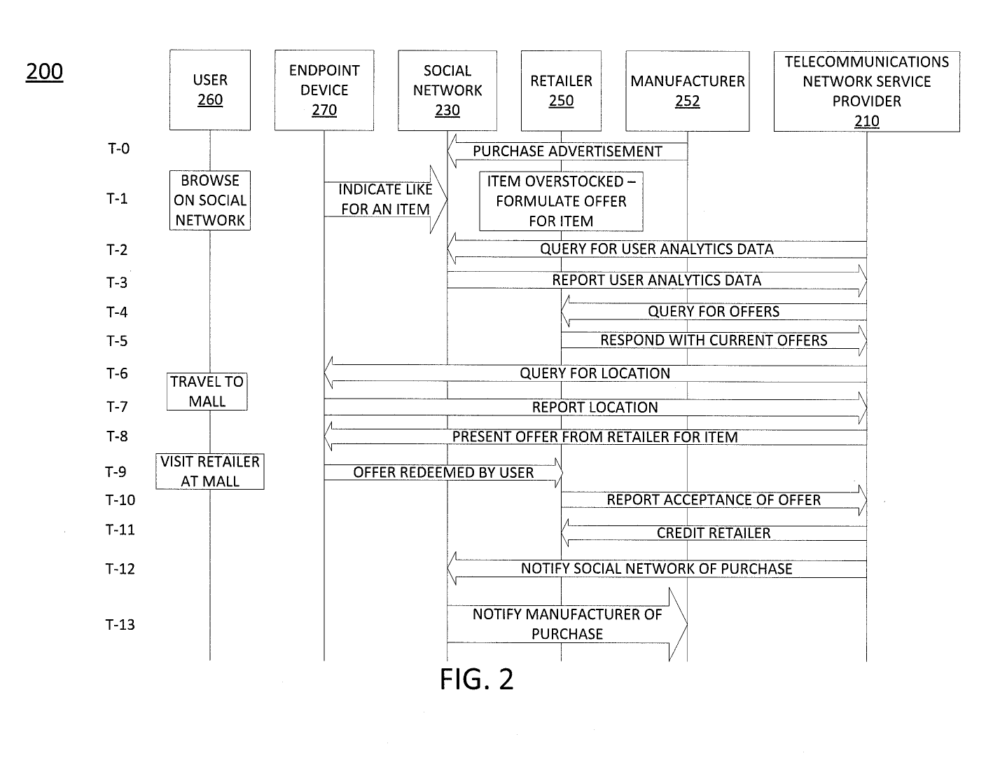

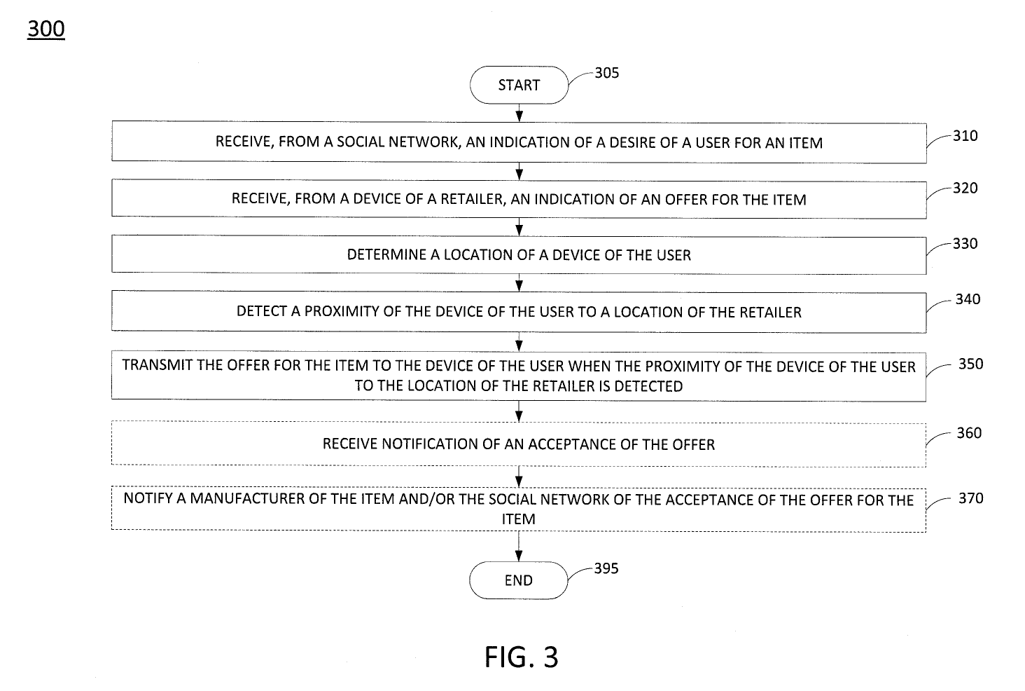

In one embodiment AS 115 may then match an offer to a user based upon the need, desire and/or interest of the user in a particular item, the current location of the user and the availability of the offer from the retailer for the item, where the offer is applicable to the geographic area in which the user is located. For example, as illustrated in FIG. 1, user 160 may have an interest in item 190, which the user has expressed in the context of online social network 130. Thus, social network 130 may store this particular desire of the user 160 as part of the analytics data relating to user 160 in DB 126 of AS 125. In addition, AS 115 may obtain this analytics data by querying social network 130 for an update of the analytics data relating to user 160. Moreover, in the present example the retailer associated with retailer device 150 may notify AS 115 of a current offer for item 190 that is applicable to users within a 500 meter radius of the retailer's store in city X. AS 115 may then later determine that user 160 is located within 500 meters of the store, e.g., based upon GPS information of user 160's endpoint device 170, and that the offer for item 190 has not expired. Thus, AS 115 may present to the user 160 the offer from the retailer for item 190. For example, AS 115 may send a text message, short message service (SMS) message, a multimedia messaging service (MMS) message, an email and so forth to endpoint device 170. A further discussion of these and similar functions follows below in connection with the examples of FIGS. 2 and 3.

It should be noted that the network 100 has been simplified. For example, the network 100 may include other network elements (not shown) such as border elements, routers, switches, policy servers, security devices, gateways, a content distribution network (CDN) and the like. Thus, FIG. 1 is only intended to illustrate one exemplary environment in which embodiments of the present disclosure may be employed.

To further aid in understanding the present disclosure, FIG. 2 illustrates an exemplary timing diagram 200 of a communication system according to the present disclosure. For example, the timing diagram 200 may represent the communications between different components illustrated in FIG. 1 and/or similar devices. As illustrated in FIG. 2, communications take place at different times T-0 to T-13 involving an endpoint device 270 of user 260, a social network 230, a retailer 250, a manufacturer 252 and/or a telecommunications network service provider 210.

In the example of FIG. 2, at time T-0 a manufacturer of a product (or a provider of a service, e.g., an insurance company, a personal trainer, a golf instructor, and so forth) may purchase an advertisement with social network 230. At time T-1 user 260 is browsing on an online social network site of social network 230, e.g., using endpoint device 270, and indicates that he or she likes/desire a particular item. In accordance with the present disclosure, the term “item” broadly refers to either a product or a service. In one embodiment, the user 260 indicates that he or she likes the item in response to the presentation of an advertisement for the item, e.g., the same advertisement purchased by the manufacturer 252 at time T-0. In one embodiment, the user's desire for the particular item may conveyed from endpoint device 270 to the social network 230. In turn, the social network 230 may store the user's desire for the item as part of a set of analytics data relating to user 260. Also at time T-1, retailer 250 may determine that it is overstocked with the same item. Thus, retailer 250 may formulate an offer for the item. The offer may have a particular price or discount for the item, a geographic zone in which the offer is applicable, an expiration time, and so forth.

At time T-2, the telecommunications network service provider 210 may query the social network 230 for analytics data relating to user 260, as well as to other users and/or members of the social network 230. At time T-3, the social network 230 may respond with the analytics data. Notably, in this example, the analytics data may comprise analytics data relating to user 260 which indicates the user 260's desire for the particular item.

At time T-4, the telecommunications network service provider 210 may also query retailer 250 for any current offers or any new offers that the retailer 250 would like to have presented to users. In response, at time T-5 the retailer 250 may respond with any current and/or new offers. In the present example, the response may include a new offer for the item that is overstocked (and which is the same item that user 260 desires). It should be noted that in another embodiment the retailer 250 may push new offers or changes to offers to the telecommunications network service provider 210.

At time T-6, the telecommunications network service provider 210 queries endpoint device 270 for a current location of the endpoint device 270. At time T-7, the endpoint device 270 responds with the current location. For example, the endpoint device 270 may report its location as determined from an attached or embedded GPS receiver, as determined based upon a current serving base station, and so forth. It should be noted that the present example of FIG. 2, is only one example of a system according to the present disclosure. For example, in another embodiment endpoint device 270 may periodically report its location without solicitation from the telecommunications network service provider 210. Alternatively, or in addition, a base station may report to the telecommunications network service provider 210 any endpoint device which it is currently serving. Accordingly, in some cases the telecommunications network service provider 210 may determine the location of endpoint device 270 without any input from the endpoint device itself. Thus, it should be noted that these and other variations all comprise embodiments which are within the scope of the present disclosure.

In one embodiment, at time T-8, the telecommunications network service provider 210 presents the offer from the retailer 250 for the item to the user 260 when the user 260 is within the geographic zone associated with the offer. For example, the location reported at time T-7 may indicate that endpoint device 270, and hence user 260, are located at or near a mall, or other retailer location associated with the offer. Moreover, the telecommunications network service provider 210 may match the offer to the user 260 based upon: (1) the analytics information obtained from social network 230 at time T-3 which indicates that the user 260 desires the same item that is the subject of the offer from retailer 250, and (2) the location information obtained at time T-7 which indicates that the user 260/endpoint device 270 is located in the geographic zone of the offer. Advantageously, the telecommunications network service provider 210 is able to present the offer to the user at a time and location that is more likely to generate a transaction between the user 260 and the retailer 250. For example, the user 260 has already indicated an interest and/or desire for the item, the retailer 250 is offering the item at a sale price and the user is already nearby to the retailer's location. Thus, there is little inconvenience for the user to enter the retailer's establishment and make the purchase because the user does not need to make a separate trip.

At time T-9 the user 260 may visit the retailer location, e.g., the store at the mall. In addition, the user 260 may agree to redeem the offer from the retailer. Thus, at time T-10 the retailer 250 may report to telecommunications network service provider 210 an acceptance of the offer by the user 260. In one embodiment, at time T-11, the telecommunications network service provider 210 credits an account of the retailer 250. For example, in one embodiment the telecommunications network service provider 210 may act as a trusted intermediary to process transaction payments. Thus, the telecommunications network service provider 210 may debit a telecommunications network service subscription account for user 260 for the purchase price and credit retailer 250.

At time T-12 the telecommunications network service provider 210 may also notify social network 230 of the purchase of the item. In one embodiment, the notification may also identify the particular retailer 250 completing the sale, the location of the retailer and other details. Notably, the social network 230 may desire such information to evaluate the success rates of different retailers, the prices charged in different locales, and so forth. In addition, at time T-13, the social network 230 may notify the manufacturer 252 of the purchase. In one embodiment, the social network 230 may provide the same additional information provided by the telecommunications network service provider at time T-12. For example, the manufacturer 252 may also desire such information to evaluate the effectiveness of advertising with social network 230, the performance of different retailers and so forth. In addition, the social network 230 may present such information to demonstrate to manufacturer 252 the effectiveness of the advertisement with social network 230.

Again, it should be noted that the timing diagram 200 of FIG. 2 comprises only one exemplary scenario for a system for transmitting an offer for an item. Thus, several variations of the process illustrated in FIG. 2 are possible in accordance with embodiments of the present disclosure. For instance, as just one additional example, the telecommunications network service provider 210 may directly notify the manufacturer 252 of the purchase/acceptance of the offer. For example, the manufacturer 252 may be notified of the occurrence of the sale as well as the process involving the retailer 250 and/or the social network 230 in bringing about the sale. In any case, the process of FIG. 2 correlates two independent events, (1) the purchase of an advertisement by the manufacturer 252 with the social network 230 and (2) the purchase of a product in store of a retailer 250 by user 260. Thus, the manufacturer 252, as well as any of the other parties involved, is provided with a success metric of the advertisement with social network 230.

FIG. 3 illustrates a flowchart of a method 300 for transmitting an offer for an item, according to the present disclosure. In one embodiment, steps, functions and/or operations of the method 300 may be performed by a network-based device, e.g., application server 115, in FIG. 1. In one embodiment, the steps, functions, or operations of method 300 may be performed by a computing device or system 400, and/or processor 402 as described in connection with FIG. 4 below. For illustrative purpose, the method 300 is described in greater detail below in connection with an embodiment performed by a processor, such as processor 402. The method begins in step 305 and proceeds to optional step 310.

At step 310, the method 300 receives from a social network an indication of a desire of a user for an item. For example, the user may be browsing online via an online social network site and indicate to the social network a desire for a particular product or service. For instance, the user may desire a new suitcase, new shoes, tickets to a concert or a sporting event, and so forth. In one embodiment, the social network stores analytics data, broadly referred to herein as social network information, pertaining to the user's social network activities. For example, the analytics data may include raw data pertaining to the user's usage of the social network. Alternatively, or in addition, the social network information may contain indication of the interest and/or desire of the user for the particular item. In other words, in various embodiments the usage data for the user may be pre-evaluated to differing degrees by the social network. Accordingly, in one embodiment the method 300 queries the social network to retrieve the analytics data. However, in another embodiment, the social network provides the analytics data on a periodic basis. In one embodiment, the method 300 subscribes to a social network analytics data service by which the social network undertakes to provide analytics data on a regular basis or on demand.

In one embodiment, the method 300 analyzes the analytics data from the social network to determine one or more interests and/or desires of the user for various products and services. For instance, in the present example the method 300 may determine the user's interest in the particular item, which the user has explicitly indicated that he or she desires. Alternatively or in addition, the method 300 may determine the desire of the user for the item based upon social network information/analytics data pertaining to one or more contacts of the user. For example, one or more of the user's contacts may also indicate a desire for the same item. In another embodiment, the determination of the desire of the user for the item may be based upon analytics data indicating that the user has an affinity for a particular manufacturer. For example, the user may explicitly indicate an affinity or desire for a particular brand of handbags. Thus, the user may not have a desire for an explicit model, but is broadly interested in all handbags from the manufacturer.

At step 320, the method 300 receives from a device of a retailer an indication of an offer for the item. For instance, in one example a retailer may be overstocked in the same item that the above user desires. In addition, the retailer may plan to present the item at a discounted price. In another example, the retailer may simply intend to sell the item and engage in a sale and advertising campaign. In any case, the retailer may formulate an offer pertaining to the item, a duration and/or expiration time, a geographic range, and so forth. For example, the retailer may specify that the offer is applicable only to users in a geographic area based on a threshold distance around a store or other location of the retailer. In one embodiment, the method 300 may periodically query the retailer for new offers or current offers. In another embodiment, the retailer may proactively provide new offers, changes to existing offers and so forth to the method 300.

At step 330, the method 300 determines a location of a device of the user. The method may track a location of the device of the user in various ways. For example, in one embodiment the method determines the location by periodically querying the device to provide location information. In another embodiment, each base station in a telecommunications service provider network provides an indication of each endpoint device that the base station is presently serving. Thus, in this example, the method 300 may track the location of the device of the user based upon the current serving base station.

At step 340, the method detects a proximity of the device of the user to a location of the retailer. For example, as mentioned above the offer from the retailer for the particular item may also specify an applicable geographic area surrounding a location of the retailer. For instance, the offer may specify that the offer is applicable to users who are located at the same mall in which the retailer's store is located. Alternatively or in addition, the offer may specify that it is only applicable to users who are within 200 meters, 500 meters or other threshold distance from the retailer's store. Thus, in one example, the method 300 detects a proximity to a location of the retailer when the device of the user is determined to be within the threshold distance from the retailer's location.

In step 350, the method 300 transmits the offer to the device of the user. In particular, if the user is within the area in which the offer is applicable, e.g., if a proximity of the user to the location of the retailer is detected, and if the method has also determined that the user has a desire for the item which is the subject of the offer, then the method may convey the offer to the device of the user at step 350. In one embodiment, the method 300 may transmit the offer as a text message, short message service (SMS) message, a multimedia messaging service (MMS) message, an email and so forth.

Following step 350, the method 300 may proceed to step 395 where the method ends, or may proceed to optional step 360.

At optional step 360, the method 300 may receive a notification of an acceptance of the offer. For example, the user may actually visit the location of the retailer in response to the offer and complete the purchase of the item for which the user had previously indicated a desire. In one embodiment, the notification may be received from the retailer. In another embodiment, the notification may be received from the device of the user. In addition, in one embodiment, the method 300 may perform payment processing for the transaction at optional step 360. For instance, the method 300 may debit a telecommunication network service subscription account for the user. The method 300 may then credit the retailer for the sale price. Notably, no previous connection or transaction history between the user and the retailer is required.

At optional step 370, the method 300 may notify the social network and/or a manufacturer of the item of the acceptance of the offer for the item. In one embodiment, the notification includes an identification of the retailer completing the sale, the location of the retailer and other details. Notably, the manufacturer may desire such information to evaluate the success rates of different retailers, the prices charged in different locales, and so forth. In addition the manufacturer and/or the social network may desire such information to evaluate the effectiveness of the manufacturer's advertisement with the social network.

Following any of steps 350-370, the method 300 proceeds to step 395 where the method ends.

In addition, although not specifically specified, one or more steps, functions or operations of the method 300 may include a storing, displaying and/or outputting step as required for a particular application. In other words, any data, records, fields, and/or intermediate results discussed in the method can be stored, displayed and/or outputted either on the device executing the method or to another device, as required for a particular application.

Furthermore, steps, blocks, functions or operations in FIG. 3 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the example embodiments of the present disclosure.

FIG. 4 depicts a high-level block diagram of a general-purpose computer suitable for use in performing the functions described herein. As depicted in FIG. 8, the system 400 comprises one or more hardware processor elements 402 (e.g., a central processing unit (CPU), a microprocessor, or a multi-core processor), a memory 404, e.g., random access memory (RAM) and/or read only memory (ROM), a module 405 for transmitting an offer for an item, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the general-purpose computer may employ a plurality of processor elements. Furthermore, although only one general-purpose computer is shown in the figure, if the method(s) as discussed above is implemented in a distributed or parallel manner for a particular illustrative example, i.e., the steps of the above method(s) or the entire method(s) are implemented across multiple or parallel general-purpose computers, then the general-purpose computer of this figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer-readable instructions pertaining to the method(s) discussed above can be used to configure a hardware processor to perform the steps, functions and/or operations of the above disclosed methods. In one embodiment, instructions and data for the present module or process 405 for transmitting an offer for an item (e.g., a software program comprising computer-executable instructions) can be loaded into memory 404 and executed by hardware processor element 402 to implement the steps, functions or operations as discussed above in connection with the exemplary method 300. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for transmitting an offer for an item (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for transmitting an offer for an item, the method comprising:
receiving, by a processor from a social network, an indication of a desire of a user for the item;
receiving, by the processor from a device of a retailer, an indication of the offer for the item;
determining, by the processor, a location of a device of the user;
detecting, by the processor, a proximity of the device of the user to a location of the retailer; and
transmitting, by the processor, the offer for the item to the device of the user when the proximity of the device of the user to the location of the retailer is detected.

2. The method of claim 1, wherein the processor comprises a processor of a telecommunications network service provider network.

3. The method of claim 1, further comprising:
receiving a notification of an acceptance of the offer for the item.

4. The method of claim 3, further comprising:
charging a telecommunications network service subscription account of the user for a cost of the item.

5. The method of claim 4, further comprising:
crediting an account of the retailer for the cost of the item.

6. The method of claim 3, further comprising:
notifying the social network of the acceptance of the offer for the item.

7. The method of claim 3, further comprising:
notifying a manufacturer of the item of the acceptance of the offer for the item.

8. The method of claim 7, further comprising:
notifying the manufacturer of the location of the retailer after receiving the acceptance of the offer for the item from the device of the user.

9. The method of claim 1, wherein the offer for the item is transmitted to the device of the user based upon the indication of the desire of the user for the item.

10. The method of claim 1, wherein the offer for the item comprises a discounted price for the item.

11. The method of claim 1, wherein the indication of the desire of the user for the item is based upon the user explicitly indicating the desire for the item.

12. The method of claim 11, wherein the indication of the desire of the user for the item is provided in response to an advertisement of a manufacturer of the item presented to the user via the social network.

13. The method of claim 1, wherein the indication of the desire of the user for the item is based upon the user explicitly indicating an affinity for a manufacturer of the item.

14. The method of claim 1, wherein the indication of the desire of the user for the item is based upon contacts of the user explicitly indicating a desire for the item.

15. The method of claim 1, wherein the proximity of the device of the user to the location of the retailer comprises a threshold distance that is selected by the retailer.

16. The method of claim 1, wherein the item comprises a product.

17. The method of claim 1, wherein the item comprises a service.

18. A computer-readable storage device storing instructions which, when executed by a processor, cause the processor to perform operations for transmitting an offer for an item, the operations comprising:
receiving, from a social network, an indication of a desire of a user for the item;
receiving, from a device of a retailer, an indication of the offer for the item;
determining a location of a device of the user;
detecting a proximity of the device of the user to a location of the retailer; and
transmitting the offer for the item to the device of the user when the proximity of the device of the user to the location of the retailer is detected.

19. The computer-readable storage device of claim 18, wherein the operations further comprise:
receiving a notification of an acceptance of the offer for the item.

20. An apparatus for transmitting an offer for an item, the apparatus comprising:
a processor; and
a computer-readable storage device storing a instructions which, when executed by the processor, cause the processor to perform operations, the operations comprising:
receiving, from a social network, an indication of a desire of a user for the item;
receiving, from a device of a retailer, an indication of the offer for the item;
determining a location of a device of the user;
detecting a proximity of the device of the user to a location of the retailer; and
transmitting the offer for the item to the device of the user when the proximity of the device of the user to the location of the retailer is detected.
